(19) United States
(12) Patent Application Publication
(10) Pub. No.: US 2007/0051317 A1
(43) Pub. Date: Mar. 8, 2007

(54) Systems and methods for providing selective access to a consumable

(76) Inventor: Michael Bruner, Power Springs, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/222,080

(22) Filed: Sep. 8, 2005

(51) Int. Cl. A01K 5/02

(52) U.S. Cl. 119/53

(57) ABSTRACT

A system for selectively providing access to a consumable. The system includes an enclosure having a hollow interior for holding the consumable. A door mounted in an opening in the enclosure provides access to the interior of the enclosure at a time when the door is in a substantially open position and prevents access to the interior of the enclosure at a time when the door is in a substantially closed position. The system includes a locking mechanism for releasably locking the door in the substantially closed position and a complimentary relieving key for selectively releasing the locking mechanism.

### BACKGROUND

1. Field of the Invention

This invention relates to systems and methods for providing a consumable to an animal, and more particularly to systems and methods for selectively providing an animal access to a consumable.

2. Discussion of the Related Art

The caretakers of domesticated animals provide consumables, such as food and drink, on a regular basis. Animals may, for example, be provided the consumables from a bowl, plate, or a gravity feeder.

A gravity feeder (or waterer) can hold a relatively large quantity of consumables, thereby potentially reducing the need for a caretaker to give food to the animal on a daily basis. That is, a gravity feeder may be filled and not revisited by the caretaker for a number of days. However, because the food is freely available for a long period of time, there is an increased chance that an animal other than the intended recipient of the consumable will access and take the consumable.

It is sometimes necessary that animals confined within the same area be provided different types of consumables. For example, a household may have both a dog and a cat, each having physical access to each other's food. Because cat and dog foods are formulated for each type of animal, it can be unhealthy for the pets to eat each other's food. Additionally, some pets may require special diets, or may be given medications in their food that are not appropriate for other pets in the household. However, many pets take advantage of the open access provided by plates, bowls, and/or gravity feeders, and eat the other pet's respective food. Over time, such activity can lead to health problems in the pets, including obesity and/or weight loss.

Pets that are provided food and/or water outdoors face even tougher feeding challenges. These animals risk their food and water being taken by other freely roaming pets in the area, as well as non-domesticated animals, such as possums, raccoons, and rodents. In the case of a feeder designed to hold a great deal of food, such as a gravity feeder, the additional food consumed by animals other than the designated pet can lead to extraordinary food expenses borne by the caretaker. Furthermore, the intended recipient of the consumable may starve or dehydrate if the other animals continue to empty the feeder or waterer before the pet can obtain the food.

Accordingly, a need exists to rectify the issues associated with providing a designated animal access to consumables, while preventing the consumables from being consumed by other animals.

### SUMMARY

An embodiment of a system for selectively providing access to a consumable includes an enclosure having a hollow interior. The enclosure includes a first opening for adding the consumable to the hollow interior and a second opening for providing access to the consumable in the hollow interior. The system further includes a door pivotally mounted in the second opening for allowing access to the interior of the enclosure at a time when the door is in a substantially open position and preventing access to the interior of the enclosure at a time when the door is in a substantially closed position. The system further includes means for releasably locking the door in the substantially closed position and means for selectively releasing the means for releasably locking the door.

Another exemplary embodiment is directed to an animal feeding system. The system includes a gravity feeder having a hollow interior and a door for providing access to the hollow interior when in a substantially open position and preventing access to the hollow interior when in a substantially closed position. The system further includes a locking mechanism for releasably locking the door in the substantially closed position, and a relieving key for selectively releasing the locking mechanism.

Another exemplary embodiment is directed to a system for providing a consumable to an animal. The system includes an enclosure having a dispensing portion within a hollow interior, and a door for providing access to the dispensing portion when in a substantially open position and preventing access to the dispensing portion when in a substantially closed position. A locking door system is configured to lock the door in the substantially closed position and unlock the door upon sensing the presence of an emission from a relieving key.

Yet another exemplary embodiment is directed to a method for selectively providing access to the interior of a hollow enclosure. The method includes: placing a consumable in a dispensing portion of the hollow enclosure; locking a door in a substantially closed position to prevent access to the dispensing portion of the hollow enclosure; and unlocking the door upon receiving an emission from a relieving key.

Another exemplary embodiment is directed to a method for selectively providing consumables to animals. The method may include placing a first consumable designated for a first animal in a first hollow enclosure and placing a second consumable designated for a second animal in a second hollow enclosure. Access to the first hollow enclosure is prevented with a first locking mechanism until a distinguishing emission keyed to the first locking mechanism is received, and access to the second hollow enclosure is prevented with a second locking mechanism until a distinguishing emission keyed to the second locking mechanism is received.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of an embodiment of the disclosed animal feeding system.

FIG. 2 is a cut-away, side view of the animal feeding system of FIG. 1, with a view to the interior of the hollow enclosure, while the door is in a substantially closed position.

FIG. 3. is a cut-away, side view of the animal feeding system of FIG. 1, with a view to the interior of the hollow enclosure, while the door is in a substantially open position.

### DETAILED DESCRIPTION

Systems and methods for providing selective access to a consumable are disclosed. Although embodiments herein may be generally described as an animal feeder, it should be understood that the embodiments are not limited only to providing selective access to food, but rather, are applicable for providing any type of consumable to an animal. Such consumables may be, for example, food, water, and medication.

Additionally, while embodiments may be described as being useful for providing selective access to animals such as cats and dogs, the embodiments are equally applicable to any kind of animal, including farm animals and exotics. For example, the embodiments may be scaled to an appropriate size to provide selective access to animals such as, but not limited to, cows, pigs, ostriches, emus, horses, goats, sheep, chickens, and elephants.

The disclosed embodiments may be used for preventing animals, other than those having a relieving mechanism for unlocking a door associated with the feeder, from taking consumables from the feeder. That is, the embodiments allow only those animals having the relieving mechanism access to the consumables within the feeder.

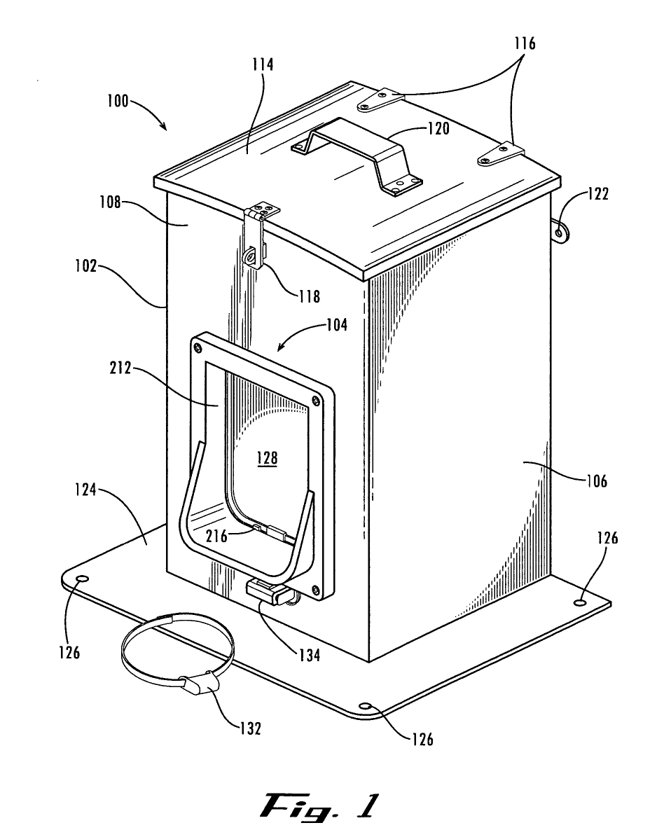

FIG. 1 depicts a perspective view of an embodiment of a system for providing selective access to a consumable. The embodiment of FIG. 1 includes an animal feeder 100 having an enclosure 102 and an automatically locking door system 104 for providing selective access to the hollow interior of the enclosure.

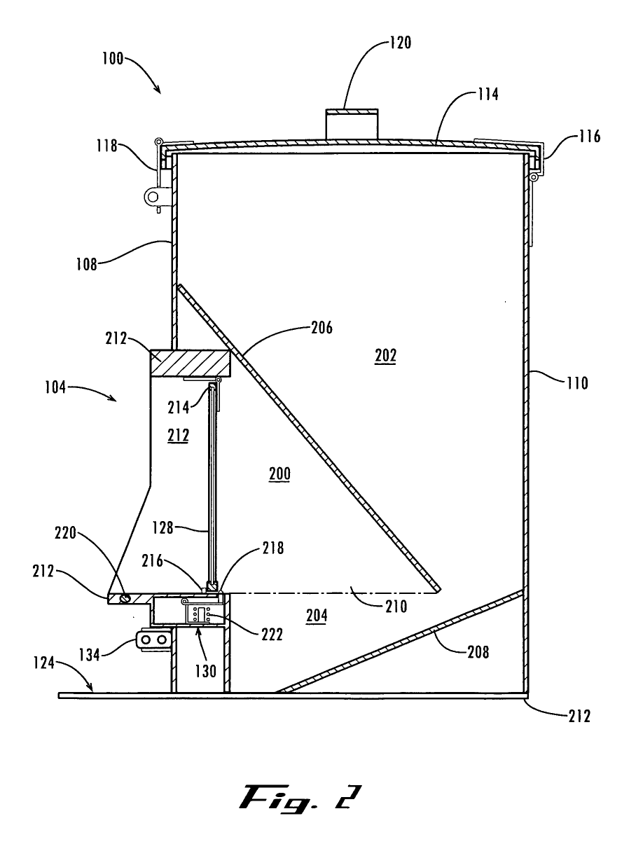

Enclosure 102 is formed by a number of walls, which include side walls 106, a front wall 108, a rear wall 110 (FIG. 2), a base wall 112 (FIG. 2), and a lid 114. Lid 114, in this embodiment, forms a top wall of the enclosure. Enclosure 102 may be formed of a number of acceptable materials such as plastics and metals. Such materials may be selected based on the size and/or strength of the animal that is being denied access to the consumable located inside of the enclosure.

Although enclosure 102 is depicted as being box shaped, any number of alternative shapes, including spherical, conical, and cylindrical, are contemplated. Lid 114 may be removably secured to the remainder of enclosure 102. For example, in the present embodiment, lid 114 is hingedly secured to rear wall 110 by lid hinges 114, and further secured in place by a locking latch 118. However, lid 114 could be removably secured to the enclosure in a variety of ways, including, but not limited to, other types of latches, tabs, or a threaded coupling. Lid 114 further includes a handle 120 for opening the lid and, in some cases, carrying the entire animal feeder at times when the lid is secured (e.g. via locking latch 118) to the enclosure. Lid 114 may, for example, be used to cover an opening in the enclosure used primarily to periodically add a consumable to the hollow enclosure.

Because animal feeder 100 includes the locking door system 104, animals prevented from accessing the consumables secured inside enclosure 102 may try to tip the feeder over in an effort to open the feeder and extract the contents. Accordingly, a number of devices may be used to add to the stability of animal feeder 102. For example, animal feeder 102 may be secured to another structure using a variety of available fasteners. In one embodiment, animal feeder 100 includes a rear flange 122 attached to enclosure 102 and having a hole for receiving a nail or screw to secure animal feeder 100 to a vertical wall of an abutting structure. According to another embodiment, animal feeder 100 may include a hole (not shown) in the rear wall 110 for receiving a screw or other fastener extending from an abutting structure. The hole may, for example, be a key shaped hole.

In addition to forming the bottom of enclosure 102, base wall 112 may also include a stabilizing flange 124 to provide additional stability. According to one embodiment, stabilizing flange 124 may extend outwardly a distance from the base of enclosure 102. Although stabilizing flange 124 is depicted as extending outwardly from each of side walls 106 and front wall 108, the stabilizing flange 124 may also extend in a rearward direction, which may be particularly useful if animal feeder 100 is not secured to another structure. Stabilizing flange 124 may include a number of holes 126 for receiving a fastener, such as a screw or a stake. Accordingly, animal feeder 100 can be secured to the surface of a structure or the ground upon which the animal feeder is placed. Removable stakes may be inserted through the holes 126 to removably secure animal feeder 100 to the ground. Although it can be beneficial to strongly secure animal feeder 100 to its resting surface or another structure, fastening devices that are easily removable can be desirable for cleaning purposes or when the animal feeder location is temporary, such as when used to feed the pets of transient campers and recreational vehicle (RV) users.

Automatically locking door system 104 may be positioned in an opening in a wall of the hollow enclosure to provide selective access to the hollow interior of the enclosure. Automatically locking door system 104 may comprise any number of such systems currently known, or to be later invented, that are configured to automatically lock the associated door upon its return to a substantially closed position and unlock the associated door with the use of an associated relieving key. These systems generally include a door 128, a locking mechanism 130 (FIG. 2) and a relieving key 132 for unlocking locking mechanism 130 to allow door 128 to open. Some embodiments of a locking door system 104 also include a power source 134, such as a battery. Accordingly, a battery compartment may house the power source. Access to power source 134 may be provided from outside of the animal feeder, or in an accessible location within the animal feeder.

One embodiment of the automatically locking door system 104 may comprise the “Magnetic Cat Flap” available from Reilor Limited, Preston, England. In addition to the “Magnetic Cat Flap,” Reilor also provides a number of other suitable automatically locking door systems of various sizes under their Staywell™ brand of pet products. The Reilor door systems generally operate based on the associated relieving key 132 emitting a magnetic field or emitting an infrared signal. However, a locking mechanism 130 that is activated by the detection of radio-frequency (RF) signals or other light emitting devices (visible or non-visible) from the relieving key 132 could also be used.

A number of exemplary patents disclose embodiments of additional suitable automatically locking door systems 104 that could be used with animal feeder 100. The patents disclose automatically locking door systems 104 having embodiments of a locking mechanism 130 and a relieving key 132 carried by the animal for unlocking locking mechanism 130. Such exemplary patents include U.S. Pat. No. 6,453,847 to Brooks for an “Electro-magnetically Controlled Pet Door,” U.S. Pat. No. 5,701,702 to Reid, et al. for a “Pet Door,” U.S. Pat. No. 5,469,659 to Reid, et al for a “Pet Door,” and U.S. Pat. No. 4,022,263 to Beckett et al. for a “Magnetically Actuated Cat Door,” each of which is incorporated by reference in its entirety.

In that any of the exemplary automatically locking door systems disclosed above, as well as others that are known or to be invented, could be used with embodiments of the described animal feeder 100, it is not necessary to describe the operation of the components within the numerous embodiments of the automatically locking door systems in detail. Accordingly, the details of such automatically locking door system 104 embodiments will be explained hereafter only as necessary to describe the operation of the disclosed systems and methods for providing selective access to a consumable.

Locking mechanism 130 may be described as being selective in that locking mechanism 130 can be unlocked by receiving an emission from a complimentary relieving key 132, which can be carried by a selected animal (e.g. worn on, implanted in, or otherwise attached to the animal). Animals not carrying the complimentary relieving key 132 are unable to open door 128. Accordingly, only one or more selected animals carrying the relieving key 132 are capable of opening door 128 and accessing the consumables within the enclosure 102.

In some embodiments, locking mechanism 130 may be further configured to unlock door 128 upon receiving a distinguishing emission from one or more relieving keys 132. That is, the type or contents of the emission can be used to distinguish one or more relieving keys from other relieving keys. Accordingly, an embodiment of an automatically locking door system 104 that uses distinguishing emissions adds yet another layer of selectivity.

For example, for embodiments of a relieving key 132 configured to emit a magnetic field, the strength and/or polarity of the magnet in the relieving key 132 can be selected to provide the distinguishing selectivity. The locking mechanism 130 may be configured to unlock door 128 only in the presence of the magnetic field produced by a relieving key 132 having a magnet with the selected strength and/or polarity. Other relieving keys 132 not configured with the selected magnet strength and/or polarity do not cause locking mechanism 132 to unlock.

Similarly, embodiments of a relieving key 132 may include an infrared emitter worn on the collar of a pet, and the emitter may be configured to provide a distinguishing emission. For example, the infrared emitter can be configured to emit a designated infrared frequency, or may otherwise encode an identifying signal into the infrared emissions. An infrared receiver associated with the locking mechanism 130 receives the infrared signal from relieving key 132, and corresponding circuitry associated with locking mechanism 130 may be configured to selectively unlock door 128 based on the frequency or encoding of the infrared signals emitted from the infrared relieving mechanism.

As yet another example, an RF based relieving key 132 may emit one or more RF signals encoded at an identifying frequency, or may transmit distinguishing information, such as an identification key or password, to an RF receiver associated with locking mechanism 130. Corresponding circuitry associated with locking mechanism 130 may be configured to selectively unlock the door based on the frequency of the RF signal or the information emitted from the RF based relieving key. According to one embodiment, an RF identification (RFID) tag may be used as the relieving key, and an associated RFID receiver and circuitry associated with locking mechanism 130 may receive identifying information emitted from the tag. A corresponding RFID writing device associated with the feeder could be used to write historical information to the RFID tag, such as by recording the visits an animal makes to the feeder back to the RFID tag.

Embodiments of locking door systems 104 with relieving keys having distinguishing emissions and a corresponding locking mechanism the is responsive to the identifying emissions, may be advantageous in that the relieving keys 132 may be “keyed” to unlock only a correspondingly keyed locking mechanism 130. Accordingly, each pet in a household may carry a relieving key 132 that is keyed with a distinguishing emission, allowing a correspondingly keyed locking mechanism 130 to be unlocked only by the relieving key having the distinguishing emission. Likewise, if the animal feeder is located outside, the locking mechanism 130 can be configured to unlock only in the presence of the pet having a corresponding identifying relieving key 132, while not unlocking in the presence of neighboring pets without relieving keys at all, or those animals having relieving keys that do not emit the distinguishing emission.

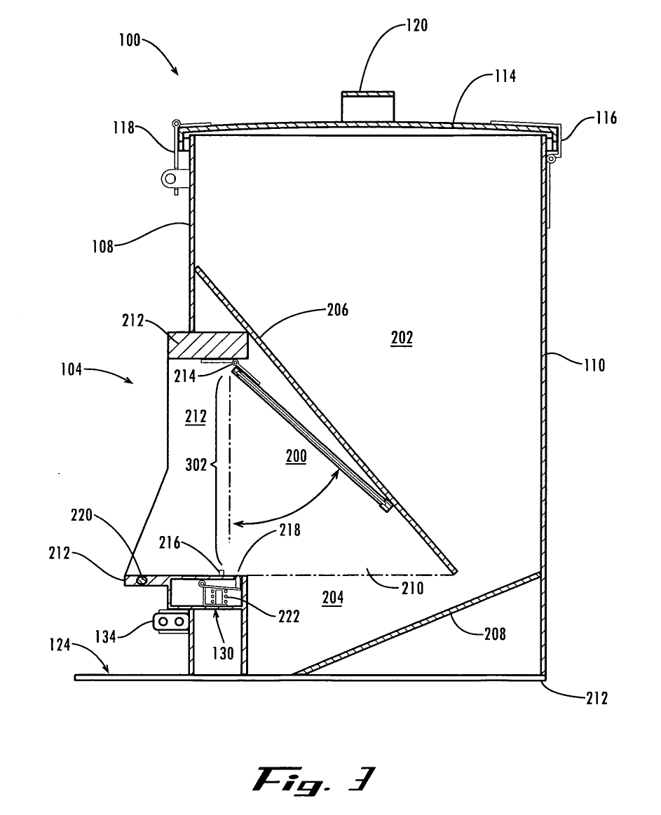

FIG. 2 depicts a cut-away, side view of the animal feeder 100 of FIG. 1 while the door 128 is located in a substantially closed position. In this substantially closed position, an animal is denied access to a hollow interior 200 of the animal feeder. FIG. 3 depicts a cut-away, side view of the animal feeder 100 of FIGS. 1 and 2 while the door 128 is located in a substantially open position. That is, FIG. 3 depicts door 128 after opening from the substantially closed position of FIG. 1, along an inward door path, to a position exposing an opening 302 large enough for an animal to access the hollow interior 200.

The cut-away portions of FIGS. 2 and 3 expose the hollow interior 200 of enclosure 102 and provide additional detail with respect to the functioning of automatically locking door system 104. With respect to hollow interior 200, one embodiment of animal feeder 100 may be described as a gravity feeder having a holding portion 202 and a dispensing portion 204. The gravity feeder maintains a quantity of consumables poured into holding portion 202 through the opening formed in enclosure 102 after unlatching and opening lid 114. An upper baffle 206 slopes downwardly from the front wall 108 towards the rear wall 110. Accordingly, upper baffle 206 maintains the added consumables within holding portion 202 while also directing the consumables away from the path of door 128. As best seen in FIG. 3, upper baffle 206 may be positioned within hollow interior 200 to allow door 128 to be opened enough for the mouth of an animal to access the dispensing portion 204.

As the dispensing portion 204 is emptied (e.g. by an animal consuming food), gravity acts on the consumable in the holding portion 202 and fills dispensing portion 204. A lower baffle 208 slopes from the rear wall 110 towards front wall 108 to direct the consumable towards the front wall 108, thereby facilitating access to the consumable by an animal through opening 302. Accordingly, a substantially constant amount of consumable is maintained in dispensing potion 204 so long as the holding portion 202 is adequately filled with the consumable.

It should be appreciated that any consumables rising above the lowest portion of opening 302 may obstruct the door 128 from opening along path. Thus, a portion of upper baffle 206 extends low enough to prevent the consumable from piling up within the inwardly opening path. For example, as illustrated with the dotted line 210 in FIG. 2, the lowermost portion of upper baffle 206 may be substantially even with respect to the lowermost portion of opening 302. The depicted positions of the lowermost portion of upper baffle 206 and the lowermost portion of door 124 are merely one of many, and the actual configuration will depend on a number of factors, including the physical properties of the consumable being dispensed and the distance between the opening 302 and the lowermost portion of upper baffle 206. However, it should be understood that the positioning of upper baffle 206 can be selected and configured to hold consumables in the holding portion 206 outside of the inwardly opening path of door 124, and to set the height of the consumable in the dispensing portion 204 of the hollow interior 200 such that the consumables in dispensing portion 204 do not obstruct the inward path of door 128.

Baffles 206 and 208 may be mounted to one or more walls of the enclosure. Although the baffles may be mounted by fixedly securing them in place, other embodiments may be removably secured to facilitate cleaning or to provide access to automatically locking door system 104. Baffles 206 and 208 may be comprised of any number of a wide variety of materials, including metals and plastics.

Now that the hollow interior 200 has been described in more detail, embodiments of automatically locking door system 104 are further described. However, it should be emphasized again that the specific mechanisms for locking door 128 in place, and subsequently unlocking door 128 to allow selective access to the hollow interior 200 should not be interpreted as being limited only to the specific embodiments described herein.

According to one embodiment of an automatically locking door system 104, door 128 is pivotally mounted in a door frame 212 about a hinge 214. Door 128 pivots about hinge 214 along the inward door path (i.e. towards the exterior of enclosure 102). A door flange 216 prevents door 128 from pivoting in an outward direction (i.e. toward the exterior of enclosure 102).

Door 128 may be locked and unlocked in any number of ways, many of which are referenced in patents and products already described. According to one potential embodiment of a locking mechanism 130, as generally disclosed in U.S. Pat. No. 6,453,847, the door 124 may be secured in the locked position with a retractable tab 218, which may also be referred to as a door catch. One or more normally open reed switches 220 are mounted coaxially in the distal edge of an extension of the lower surface of the frame 212. The reed switches 220 are connected electrically with the power source 134 and a solenoid 222. The solenoid 222 retracts the retractable tab 218 upon being energized by the power source 130 when the reed switches 220 complete the circuit, thereby unlocking door 128.

A complementary relieving key 130 (FIG. 1) for selectively releasing and unlocking the door 128 includes a magnet carried by an animal. When the animal approaches the door 128 from the left (as viewed in FIGS. 2 and 3) and the magnet enters the proximity of the reed switches 220, the switches 220 close and cause the solenoid 222 to be energized. This in turn disengages (retracts) the retractable tab 218 so the door 124 can be pushed open along the inward door path by an animal. The door 128 need only open enough to allow the animal to access consumables located in the dispensing portion 204 of the hollow interior 200.

The retractable tab 218 may be lightly spring loaded so as to normally prevent the door 128 from opening when the door is in the position depicted in FIG. 2. However, after successfully unlocking the door, the animal is able to push the door 128 to the open position as depicted in FIG. 3. After the animal has finished accessing the consumable, an angled face of the retractable tab 218 may be struck by the returning door 128, causing the tab 218 to be depressed momentarily and allowing the door to return to the closed position of FIG. 2. Once the door has returned to the substantially closed position, the spring action of retractable tab 218 returns the tab into its rest state, thereby locking door 128 in place again. Accordingly, other pets or animals that do not have a complimentary relieving key 132 (e.g. having the magnet) are denied access to the consumables inside the hollow interior.

Although embodiments of a gravity feeder have been disclosed, it should be understood that some embodiments for providing selective access to a consumable may not include a holding portion. That is, the enclosure may provide a dispensing portion without a portion for holding additional consumables.

Embodiments may also be described as a method for selectively providing access to the interior of a hollow enclosure. For example, a consumable may be placed in a dispensing portion of the hollow enclosure. A door may be locked in a substantially closed position to prevent access to the dispensing portion of the hollow enclosure. The door may be unlocked upon receiving an emission from a relieving key carried by an animal. The animal feeder may be advantageously stationed in a location accessible by both the animal carrying the relieving key and other animals, without the ability for animals not carrying the relieving key to access the consumable within the hollow enclosure.

Embodiments of a method for providing different types of consumables to a plurality of selected animals are also described. For example, the selected animals may be a dog or cat, and the selected consumables may be dog food and cat food, respectively. As another example, the selected animals may be a plurality of dogs, and the selected consumables may be formulated for one or more of the dogs. As another example, at least one of the plurality of animals may be prescribed medication, and the selected consumables may be the medication for the animal having the prescribed medication. The medication may be provided with another consumable, such as within the animals' food or water.

One embodiment, for example, may include placing a first consumable designated for a first animal in a first hollow enclosure and placing a second consumable designated for a second animal in a second hollow enclosure. Access to the first hollow enclosure is prevented with a first locking mechanism until a distinguishing emission keyed to the first locking mechanism is received, and access to the second hollow enclosure is prevented with a second locking mechanism until a distinguishing emission keyed to the second locking mechanism is received. Accordingly, an animal carrying a relieving key that emits the distinguishing emission keyed to the first locking mechanism is able to access the first hollow enclosure, but not the second hollow enclosure. Likewise, an animal carrying a relieving key that emits the distinguishing emission keyed to the second locking mechanism is able to access the second hollow enclosure, but not the first hollow enclosure.

Although the description above contains several specific embodiments, these embodiments should not be construed as limiting the scope of the invention but as merely providing illustrations of some of the presently preferred embodiments of this invention. Thus the scope of the invention should be determined by the appended claims and their legal equivalents.

1. A system for selectively providing access to a consumable comprising:
an enclosure having a hollow interior, the enclosure comprising:
a first opening for adding the consumable to the hollow interior; and
a second opening for providing access to the consumable in the hollow interior;
a door pivotally mounted in the second opening, the door allowing access to the interior of the enclosure at a time when the door is in a substantially open position and preventing access to the interior of the enclosure at a time when the door is in a substantially closed position;
means for releasably locking the door in the substantially closed position; and
means for selectively releasing the means for releasably locking the door.

2. The system of claim 1, wherein the interior of the enclosure is formed by a bottom wall, a top wall, and at least one side wall extending upwardly from the bottom wall.

3. The system of claim 2, wherein the second opening is formed in the at least one side wall.

4. The system of claim 3, further comprising:
a first baffle mounted within the interior of the hollow enclosure, the baffle sloping downwardly toward the bottom wall and away from the second opening.

5. The system of claim 4, further comprising:
a second baffle mounted within the interior of the hollow enclosure and sloping downwardly toward the bottom wall and toward the second opening, the second baffle positioned between the first baffle and the bottom wall.

6. The system of claim 4, wherein at least a portion of the first opening is above the first baffle.

7. The system of claim 1, wherein the door is pivotally mounted in the second opening with a hinge.

8. The system of claim 7, further comprising:
means for preventing the door from opening outwardly from the hollow enclosure.

9. The system of claim 1, further comprising:
a stabilizing flange extending outwardly from a bottom portion of the enclosure.

10. The system of claim 9, wherein the stabilizing flange includes at least one hole for receiving a fastener.

11. The system of claim 1, wherein the enclosure further comprises:
a baffle positioned below the first opening, the baffle angled to direct the consumable added through the first opening away from the second opening.

12. An animal feeding system comprising:
a gravity feeder having a hollow interior and a door for providing access to the hollow interior when in a substantially open position and preventing access to the hollow interior when in a substantially closed position;
a locking mechanism for releasably locking the door in the substantially closed position; and
a relieving key for selectively releasing the locking mechanism.

13. The system of claim 12, wherein the locking mechanism includes an electro-magnetically controlled catch mechanism, the catch mechanism normally preventing the opening of the door into the hollow interior of the gravity feeder.

14. The system of claim 13, wherein the relieving key comprises a magnet to be carried by an animal.

15. The system of claim 14, wherein the locking mechanism is configured to release the catch mechanism at a time when in the presence of a magnetic emission from the magnet.

16. The system of claim 12, wherein the locking mechanism is configured to unlock the door upon receipt of an emission of a radio frequency signal or an infrared signal emitted from the relieving key.

17. The system of claim 11, wherein the door is pivotally attached to the gravity feeder, the door being configured to pivot from the substantially closed position to the substantially open position along a path extending into the hollow interior of the gravity feeder, and wherein the gravity feeder further comprises:
a food opening formed within a wall of the gravity feeder; and
a baffle positioned below the food opening and inside the hollow interior, the baffle angled to direct food added through the food opening away from the path of the door.

18. A system for providing a consumable to an animal comprising:
an enclosure including:
a dispensing portion within a hollow interior; and
a door for providing access to the dispensing portion when in a substantially open position and preventing access to the dispensing portion when in a substantially closed position; and
a locking door system configured to lock the door in the substantially closed position and unlock the door upon sensing the presence of an emission from a relieving key.

19.-21. (canceled)
